(19) United States
(12) Patent Application Publication
(10) Pub. No.: US 2015/0210093 A1
(43) Pub. Date: Jul. 30, 2015

(54) PRINTER

(71) Applicant: FUNAI ELECTRIC CO., LTD., Osaka (JP)

(72) Inventors: Daisuke OGAWA, Osaka (JP); Yutaka HORI, Osaka (JP)

(21) Appl. No.: 14/603,796

(22) Filed: Jan. 23, 2015

(30) Foreign Application Priority Data
Jan. 24, 2014 (JP) 2014-011080

(51) Int. Cl. B41J 11/00

(52) U.S. Cl. CPC B41J 11/0045

(57) ABSTRACT

A printer including: a feed portion into which a medium is inserted; and a second feed tray pivoting between a first position and a second position. In the printer, both when the second feed tray is at the first position and when the second feed tray is at the second position, a feed opening of the feed portion is exposed from a direction in which the medium is inserted.

### Cross reference to Related Application

The present application is based on and claims priority of Japanese Patent Application No. 2014-011080 filed on Jan. 24, 2014. The entire disclosure of the above-identified application, including the specification, drawings and claims is incorporated herein by reference in its entirety.

### FIELD

The present invention relates to a printer that prints on a medium.

### BACKGROUND

As a printer that prints on a medium, an inkjet printer is known, for example (see Patent Literature (PTL 1), for example). A housing of the inkjet printer has a feed opening for feeding a medium into the housing. To this feed opening, a feed tray for supporting a medium in a manner to guide the medium to the feed opening is fixed. The medium supported on the feed tray is fed into the housing through the feed opening and then transported inside the housing.

Inside the housing described above, a carriage carrying ink cartridges and other components are arranged. While the carriage reciprocates in a direction substantially orthogonal to a direction in which the medium is transported, ink in the ink cartridges is discharged onto the medium, resulting in an image being printed on the medium.

### CITATION LIST

### Patent Literature

[Patent Literature 1] Japanese Unexamined Patent Application Publication No. 2004-181853

### SUMMARY

### Technical Problem

The above-described feed tray is of a size corresponding to the largest size of medium (for example, size A4) that can be printed by the inkjet printer. Therefore, when a user inserts a relatively small medium (for example, photo size, business card size, or postcard size) into the feed opening, a hand of the user contacts the feed tray, causing a problem of failure to smoothly insert the medium into the feed opening.

The present invention has been devised to solve the aforementioned problem, and an object thereof is to provide a printer having a feed opening into which relatively small media can be smoothly inserted.

### Solution to Problem

In order to achieve the aforementioned object, a printer according to an aspect of the present invention is a printer including: a feed portion into which a medium is inserted; and a feed tray pivoting between a first position and a second position, wherein both when the feed tray is at the first position and when the feed tray is at the second position, a feed opening of the feed portion is exposed from a direction in which the medium is inserted.

According to this embodiment, both when the feed tray is at the first position and when the feed tray is at the second position, a feed opening of the feed portion is exposed from a direction in which the medium is inserted. Therefore, when inserting a medium of a relatively small size (for example, photo size, business card size, or postcard size) into the feed opening, a user pivots the feed tray as described above, resulting in the feed tray being not present before the hand of the user that holds the medium, that is, the hand of the user not contacting the feed tray. Consequently, the medium of a relatively small size can be smoothly inserted into the feed opening. When inserting a medium of a relatively large size (for example, size B5 or A4) into the feed opening, installing the feed tray so as to extend from the feed opening further outward from the feed portion allows the medium of a relatively large size inserted into the feed opening to be stably supported on the feed tray.

In the printer according to an aspect of the present invention, the feed tray includes a pivot shaft extending in a direction perpendicular to a direction in which the medium is transported.

According to this aspect, the feed tray includes a pivot shaft extending in a direction perpendicular to a direction in which the medium is transported. With this, both when the feed tray is at the first position and when the feed tray is at the second position, the feed opening of the feed portion can be exposed from a direction in which the medium is inserted.

For example, it may be that the printer according to an aspect of the present invention further includes a guide movable along a longitudinal direction of the feed opening, for guiding an edge of the medium inserted into the feed opening.

According to this aspect, the printer further includes a guide and therefore is capable of guiding edges of media of various sizes by the guide, that is, by moving the guide along the longitudinal direction of the feed opening according to a size of a medium. For example, in the printer according to an aspect of the present invention, the feed tray may have a cutout larger than the guide.

According to this aspect, the feed tray has a cutout, so that the guide passes through the cutout when the feed tray is pivoted. This makes it possible to use the guide even when a user inserts a medium of a relatively small size into the feed opening.

For example, in the printer according to an aspect of the present invention, the cutout may be formed corresponding to at least one of ends of the feed opening in the longitudinal direction. According to this aspect, the cutout is formed corresponding to at least one of ends of the feed opening in the longitudinal direction. Accordingly, a support area of the feed tray which is for supporting a medium can be large.

For example, in the printer according to an aspect of the present invention, the cutout may be formed corresponding to an area ranging from one end to an other end of the feed opening in the longitudinal direction.

According to this aspect, the cutout is formed corresponding to an area ranging from one end to the other of the feed opening in the longitudinal direction. With this, in whichever position in the longitudinal direction of the feed opening the guide is located, it is possible to reduce the occurrences of the guide contacting the feed tray when the feed tray is pivoted.

For example, it may be that the printer according to an aspect of the present invention further includes a housing including the feed portion, and the feed tray is foldable along a top surface of the housing with the feed opening remaining exposed.

According to this aspect, the feed tray can be folded along the top surface of the housing with the feed opening exposed, and a user can easily fold the feed tray by grasping the feed tray and lowering it forward.

### Advantageous Effects

In the printer according to an aspect of the present invention, a medium of a relatively small size can be smoothly inserted into the feed opening.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a perspective view illustrating a printer according to Embodiment 1 when viewed from the front thereof.

FIG. 2 is a perspective view illustrating a printer according to Embodiment 1 when viewed from the rear thereof.

FIG. 3 is a perspective view illustrating a printer when viewed from the rear thereof with a second feed tray folded along a top surface of a housing.

FIG. 4 is a perspective view illustrating a printer when viewed from the front thereof with a medium of a relatively large size inserted into a feed opening.

FIG. 5 is a perspective view illustrating a printer when viewed from the rear thereof with a medium of a relatively small size inserted into a feed opening.

FIG. 6 is a perspective view illustrating a printer according to Embodiment 2 when viewed from the front thereof.

### DESCRIPTION OF EMBODIMENTS

Hereinafter, exemplary embodiments of the present invention are described in greater detail with reference to the accompanying Drawings. Note that the exemplary embodiments described below show specific examples of the present invention. The numerical values, shapes, materials, structural elements, the arrangement and connection of the structural elements, steps, and the processing order of steps, etc. shown in the following exemplary embodiments are mere examples, and therefore do not limit the present invention, the scope of which is defined in the appended Claims. Therefore, among the structural elements in the following exemplary embodiments, structural elements not recited in any one of the independent claims are described as preferred structural elements, and are not absolutely necessary to overcome the problem according to the present invention.

### Embodiment 1

### (Overall Configuration of the Printer)

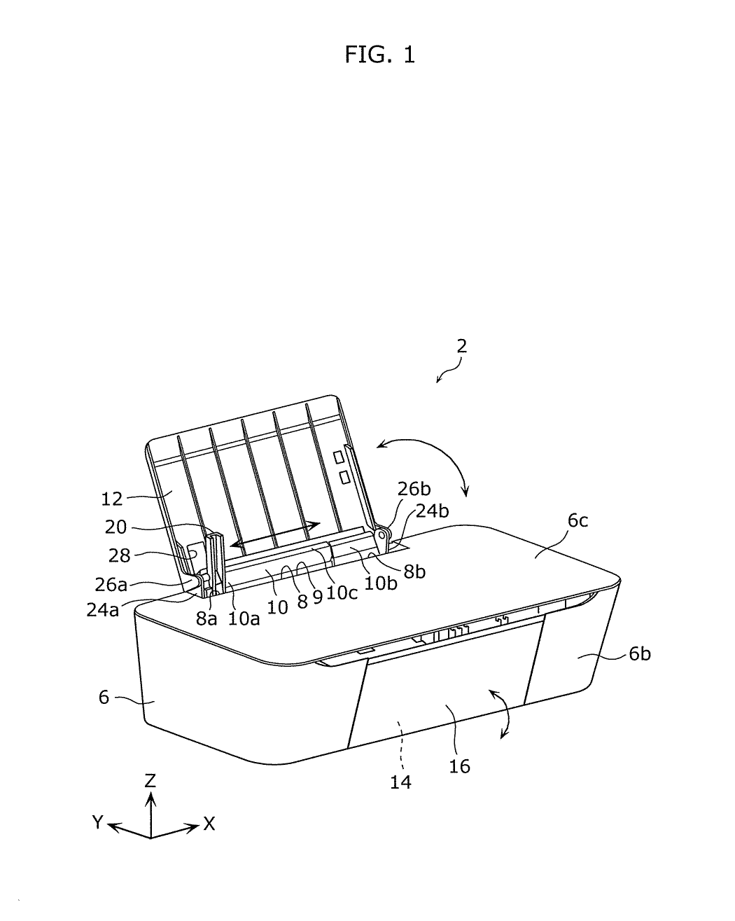

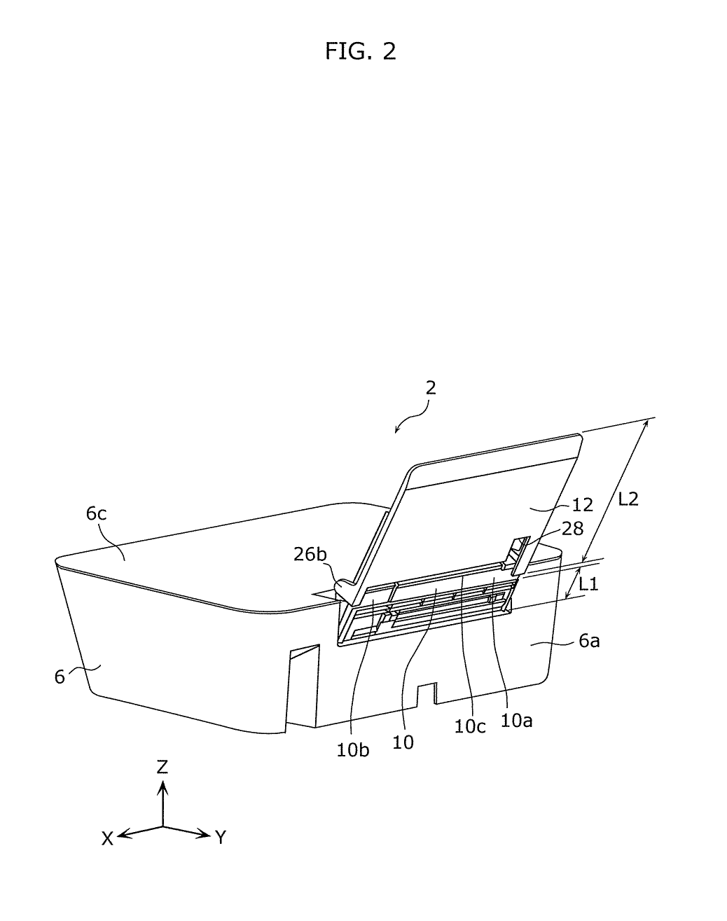

First, the overall configuration of a printer 2 according to Embodiment 1 will be described with reference to FIG. 1 and FIG. 2. FIG. 1 is a perspective view illustrating the printer according to Embodiment 1 when viewed from the front thereof. FIG. 2 is a perspective view illustrating the printer according to Embodiment 1 when viewed from the rear thereof.

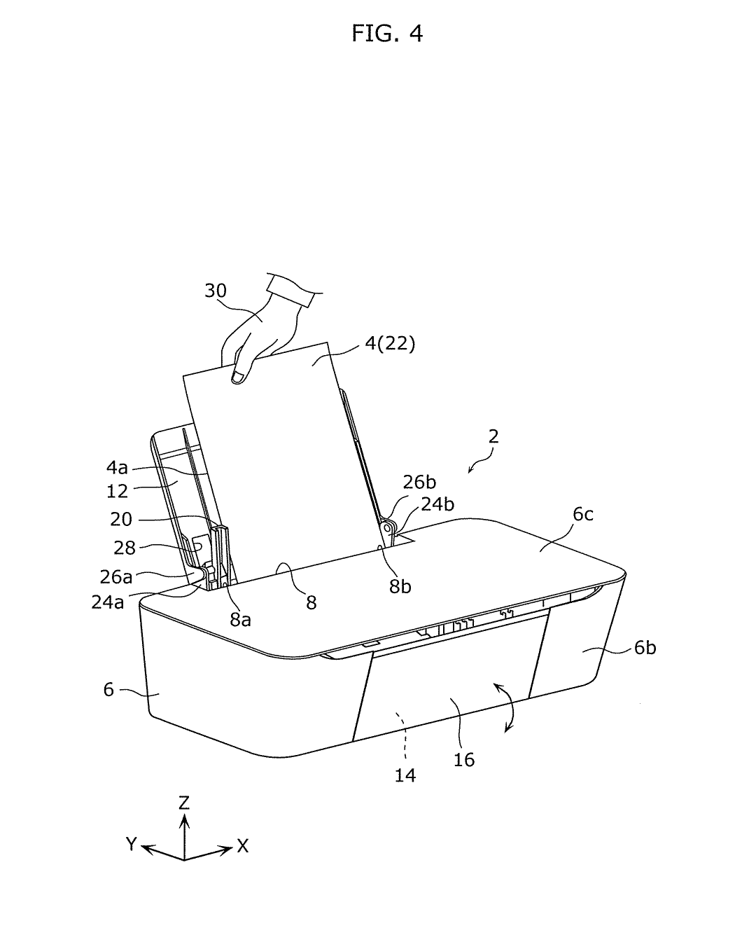

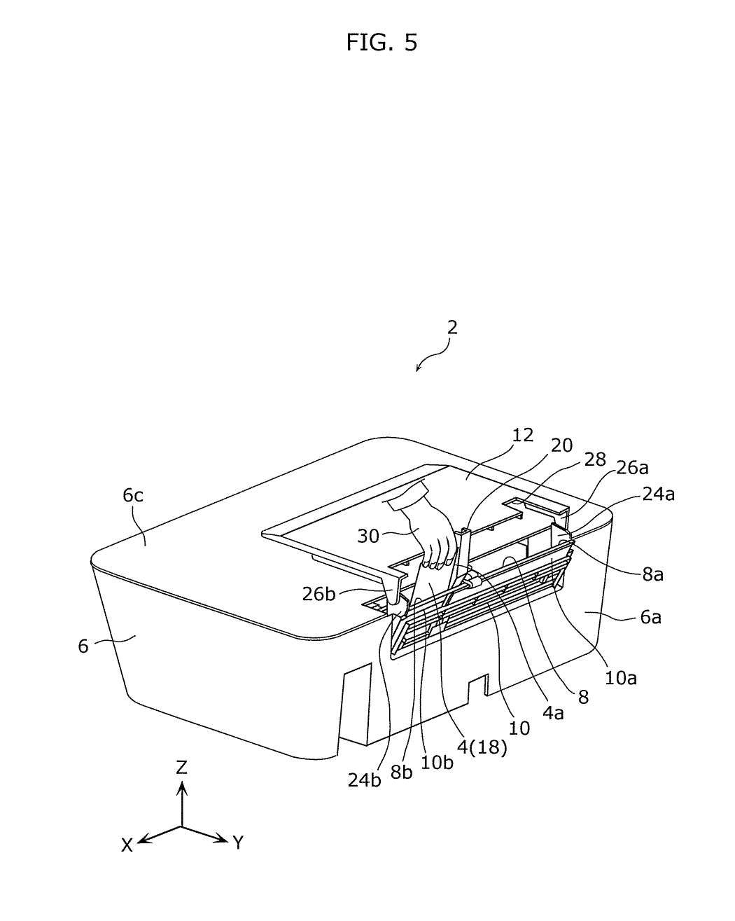

As illustrated in FIG. 1 and FIG. 2, the printer 2 is, for example, an inkjet printer which prints by discharging ink onto a medium 4 (see FIG. 4 and FIG. 5 described later). The medium 4 is plain paper or photo paper, for example.

The printer 2 includes a housing 6. The housing 6 includes, at an upper end of a rear surface 6a thereof, a feed portion 9 having a feed opening 8 for feeding into the housing 6 the medium 4 that has not yet been printed. The feed opening 8 has an elongated shape along an X axis direction. Into the feed opening 8, the medium 4 is inserted from above. The printer 2 includes a first feed tray 10 and a second feed tray 12 which are for supporting the medium 4 from behind in a manner to guide the medium 4 to the feed opening 8. Note that the second feed tray 12 is an example of a feed tray. The structures of the first feed tray 10 and the second feed tray 12 will be described later.

The housing 6 has, in a front surface 6b, an output opening 14 for outputting to the outside of the housing 6 the medium 4 that has been printed. At the output opening 14, an output tray 16 which can be opened and closed is provided. The output tray 16 pivots between a closed position (see FIG. 1) at which the output tray 16 covers the output opening 14 and an open position (not shown) at which the output tray 16 opens the output opening 14 by being pulled out of the output opening 14. When the output tray 16 is at the open position, the medium 4 outputted from the output opening 14 is supported from below by the output tray 16.

The housing 6 includes, in a top surface 6c, a control panel (not shown) for operating the printer 2 (for example, powering ON and OFF or starting printing).

Although not shown, a transporting mechanism, a carriage, and other components are arranged inside the housing 6. The transporting mechanism is for transporting toward the output opening 14 the medium 4 fed into the housing 6 through the feed opening 8. The carriage is loaded with ink cartridges that are replaceable. While the carriage reciprocates in a direction substantially orthogonal to a direction in which the medium 4 is transported, ink in the ink cartridges is discharged onto the medium 4, resulting in an image being printed on the medium 4.

### (Structure of the First Feed Tray)

Next, the structure of the first feed tray 10 described above will be described with reference to FIG. 1 and FIG. 2.

As illustrated in FIG. 1 and FIG. 2, the first feed tray 10 laterally extends along a longitudinal direction of the feed opening 8 (the X axis direction) from a first end 8a to a second end 8b of the feed opening 8 in the longitudinal direction. Furthermore, the first feed tray 10 extends obliquely upward from the feed opening 8 toward the outside of the housing 6. The first feed tray 10 is of a size corresponding to a medium 18 (see FIG. 5 described later) of a relatively small size (for example, photo size, business card size, or postcard size). Specifically, as illustrated in FIG. 2 and later-described FIG. 5, a length L1 of the first feed tray 10 is set such that an upper edge of the medium 18 of a relatively small size inserted into the feed opening 8 protrudes, for example, approximately a few millimeters to a few centimeters from a distal edge 10c of the first feed tray 10. Note that the length L1 of the first feed tray 10 is preferably such that a length thereof between the bottom of a feed roller (not shown) and an upper end of the feed opening 8 is at least two-thirds of the medium 18.

At the feed opening 8, a guide 20 is provided. The guide 20 is for guiding an edge 4a of the medium 4 inserted into the feed opening 8 (see later-described FIG. 4 and FIG. 5). The guide 20 can move between the first end 8a and the second end 8b of the feed opening 8 in the longitudinal direction by sliding along the longitudinal direction of the feed opening 8. A user slides the guide 20 according to a size of the medium 4 inserted into the feed opening 8. For example, as illustrated in FIG. 4 described later, a user slides the guide 20 to the first end 8a of the feed opening 8 when inserting a medium 22 of a relatively large size (for example, size A4) into the feed opening 8. As illustrated in FIG. 5 described later, a user slides the guide 20 to a position between the first end 8a and the second end 8b of the feed opening 8 when inserting the medium 18 of a relatively small size (for example, postcard size) into the feed opening 8.

Furthermore, bearing portions 24a and 24b are provided on a first end 10a and a second end 10b of the first feed tray 10, respectively.

### (Structure of the Second Feed Tray)

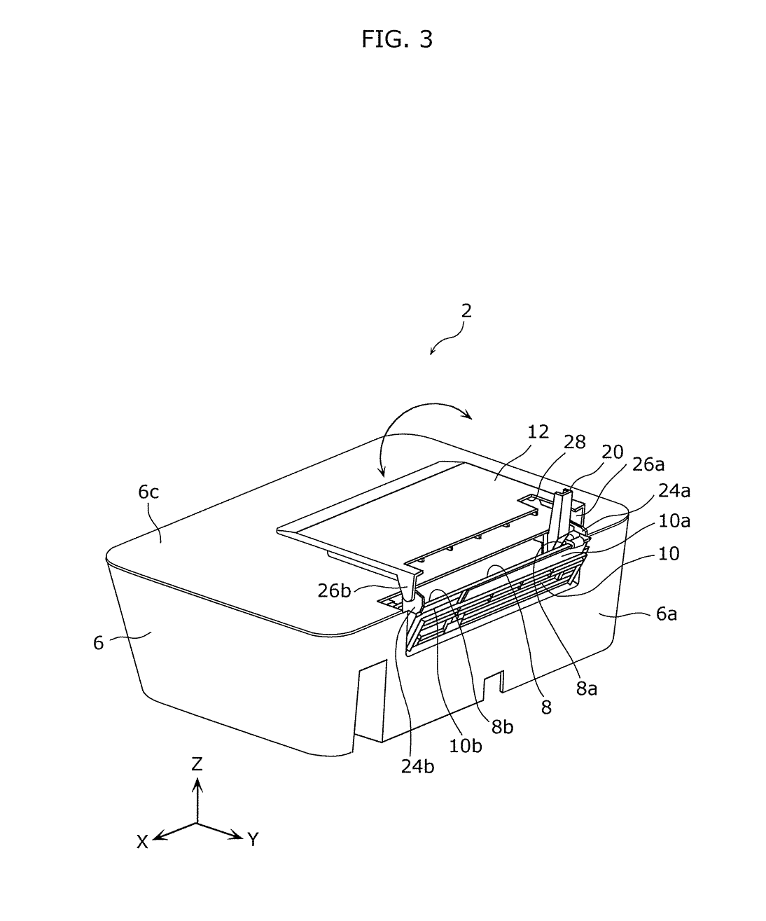

Next, the structure of the second feed tray 12 described above will be described with reference to FIG. 3 in addition to FIG. 1 and FIG. 2. FIG. 3 is a perspective view illustrating the printer from the rear thereof with the second feed tray folded along the top surface of the housing.

As illustrated in FIG. 1 and FIG. 2, shaft portions 26a and 26b (pivot shafts) extending in a direction perpendicular to a direction in which the medium 4 is transported are provided on both ends of a proximal edge of the second feed tray 12, respectively. These shaft portions 26a and 26b pivot on the above-described bearing portions 24a and 24b of the first feed tray 10. Thus, the second feed tray 12 pivots between a first position (see FIG. 1 and FIG. 2) and a second position (see FIG. 3) on the shaft portions 26a and 26b (that is, on an axis extending in the longitudinal direction of the feed opening 8).

When being at the first position, the second feed tray 12 extends further from the distal edge 10c of the first feed tray 10 obliquely upward to the outside of the housing 6 as illustrated in FIG. 1 and FIG. 2. In other words, the second feed tray 12 extends substantially parallel with the first feed tray 10. At this time, the second feed tray 12 forms a support surface which supports the medium 4 together with the first feed tray 10.

When being at the second position, the second feed tray 12 is folded along the top surface 6c of the housing 6 as illustrated in FIG. 3. At this time, the feed opening 8 is not covered by the second feed tray 12 and is exposed to the outside of the printer 2 on the opposite side from the side of the second feed tray 12 on which the medium 4 is supported (that is, on the first feed tray 10 side).

As illustrated in FIG. 2 and later-described FIG. 4, a length L2 of the second feed tray 12 is set such that an upper edge of the medium 22 of a relatively large size (for example, size B5 or A4) inserted into the feed opening 8 protrudes, for example, approximately a few millimeters to a few centimeters from a distal edge of the second feed tray 12.

The second feed tray 12 includes, at the proximal edge, a cutout 28 in a rectangular form. The cutout 28 is formed corresponding to the first end 8a of the feed opening 8 in the longitudinal direction. The cutout 28 is larger than the guide 20. This allows the guide 20 to pass through the cutout 28 when the second feed tray 12 pivots between the first position and the second position.

### (Usage of the First Feed Tray and the Second Feed Tray)

Next, usage of the first feed tray 10 and the second feed tray 12 when the medium 22 of a relatively large size is inserted into the feed opening 8 is described with reference to FIG. 4. FIG. 4 is a perspective view illustrating the printer when viewed from the front thereof with the medium of a relatively large size inserted into the feed opening.

As illustrated in FIG. 4, when inserting the medium 22 of a relatively large size (for example, size A4) into the feed opening 8, a user slides the guide 20 to the first end 8a of the feed opening 8 and then pivots the second feed tray 12 from the first position to the second position. At this time, the guide 20 passes through the cutout 28 of the second feed tray 12 and therefore does not contact the second feed tray 12. Thereafter, the user inserts the medium 22 of a relatively large size into the feed opening 8 with the guide 20 guiding an edge 4a of the medium 22. Thus, together with the first feed tray 10, the second feed tray 12 supports, from behind, the medium 22 inserted into the feed opening 8.

Next, usage of the first feed tray 10 and the second feed tray 12 when the medium 18 of a relatively small size is inserted into the feed opening 8 is described with reference to FIG. 5. FIG. 5 is a perspective view illustrating the printer when viewed from the rear thereof with the medium of a relatively small size inserted into the feed opening.

As illustrated in FIG. 5, when inserting the medium 18 of a relatively small size (for example, postcard size) into the feed opening 8, a user slides the guide 20 to the first end 8a of the feed opening 8 first and then pivots the second feed tray 12 from the first position to the second position. At this time, the guide 20 passes through the cutout 28 of the second feed tray 12 and therefore does not contact the second feed tray 12 as in the above-described case. Thereafter, the user inserts the medium 18 of a relatively small size into the feed opening 8. The user then slides the guide 20 to a position between the first end 8a and the second end 8b of the feed opening 8 so that an edge 4a of the medium 18 is guided by the guide 20. Thus, the first feed tray 10 supports, from behind, the medium 18 inserted into the feed opening 8.

### (Advantageous Effect)

Next, the advantageous effects of the printer 2 according to Embodiment 1 will be described. As described above, when inserting the medium 18 of a relatively small size into the feed opening 8, a user folds the second feed tray 12 along the top surface 6c of the housing 6 by pivoting the second feed tray 12 from the first position to the second position. As a result, the second feed tray 12 is not present before a hand 30 of a user that holds the medium 18, and the hand 30 of the user does not therefore contact the second feed tray 12, as illustrated in FIG. 5. Consequently, the medium 18 of a relatively small size can be smoothly inserted into the feed opening 8.

Furthermore, since the first feed tray 10 is provided at the feed opening 8, the medium 18 of a relatively small size inserted into the feed tray 8 can be supported on the first feed tray 10 even when the second feed tray 12 is folded along the top surface 6c of the housing 6.

When inserting the medium 22 of a relatively large size into the feed opening 8, pivoting the second feed tray 12 from the second position to the first position can result in the medium 22 of a relatively large size inserted into the feed opening 8 being stably supported on the first feed tray 10 and the second feed tray 12.

Furthermore, when the second feed tray 12 pivots between the first position and the second position, the guide 20 passes through the cutout 28 of the second feed tray 12. Therefore, the guide 20 can be used even when the second feed tray 12 is folded along the top surface 6c of the housing 6.

### Embodiment 2

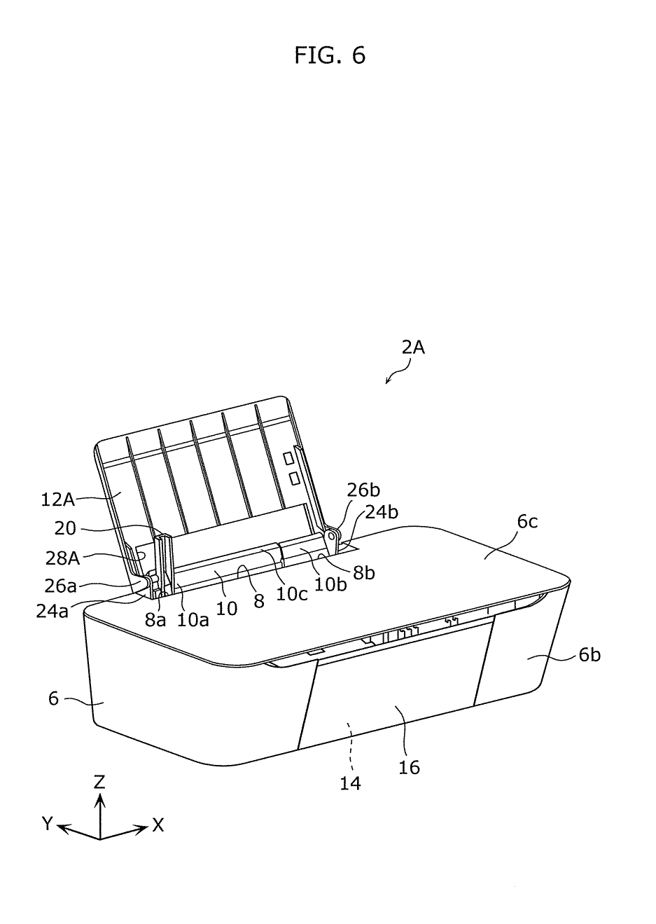

Next, the structure of a printer 2A according to Embodiment 2 will be described with reference to FIG. 6. FIG. 6 is a perspective view illustrating the printer according to Embodiment 2 when viewed from the front thereof. Note that in Embodiment 2, the structural elements that are the same as in Embodiment 1 have the same reference numerals as in Embodiment 1, and descriptions thereof are omitted.

As illustrated in FIG. 6, the printer 2A according to Embodiment 2 is different in shape of a cutout 28A from Embodiment 1 described above. Specifically, the cutout 28A is formed so as to be laterally long corresponding to an area ranging from the first end 8a to the second end 8b of the feed opening 8.

With this, in whichever position in the longitudinal direction of the feed opening 8 the guide 20 is located, it is possible to reduce the occurrences of the guide 20 contacting the second feed tray 12A when the second feed tray 12A is pivoted.

The printer has herein been exemplified based on Embodiments 1 and 2 of the present invention, but the present invention is not limited to Embodiments 1 and 2 described above.

In each of the above embodiments, the printer 2 (2A) is exemplified as an inkjet printer, but other than an inkjet printer, the printer may be, for example, a laser printer or a thermal printer.

In Embodiment 1 described above, the cutout 28 is formed corresponding to the first end 8a of the feed opening 8, but the present invention is not limited to this example. For example, the cutout 28 may be formed corresponding to the second end 8b of the feed opening 8. Alternatively, the cutout 28 may be formed corresponding to a position between the first end 8a and the second end 8b of the feed opening 8. Alternatively, more than one cutout 28 may be formed; for example, it may be that the cutout 28 is formed corresponding to each of the first end 8a and the second end 8b of the feed opening 8.

In each of the above embodiments, the second feed tray 12 (12A) is exemplified as being foldable along the top surface 6c of the housing 6, but the present invention is not limited to this example. The second feed tray 12 (12A) may be foldable along another surface (for example, the rear surface 6a) of the housing 6.

In each of the above embodiments, the medium 18 of a relatively small size is exemplified as photo paper, a business card, a postcard, or the like, but other than these examples, this may be a compact disc read only memory (CD-ROM) having a printable label surface, for example.

### INDUSTRIAL APPLICABILITY

The printer according to an aspect of the present invention is applicable as, for example, an inkjet printer which prints by discharging ink onto a medium.

1. A printer comprising:
a feed portion into which a medium is inserted; and
a feed tray pivoting between a first position and a second position,
wherein both when the feed tray is at the first position and when the feed tray is at the second position, a feed opening of the feed portion is exposed from a direction in which the medium is inserted.

2. The printer according to claim 1,
wherein the feed tray includes a pivot shaft extending in a direction perpendicular to a direction in which the medium is transported.

3. The printer according to claim 1, further comprising
a guide movable along a longitudinal direction of the feed opening, for guiding an edge of the medium inserted into the feed opening.

4. The printer according to claim 3,
wherein the feed tray has a cutout larger than the guide.

5. The printer according to claim 4,
wherein the cutout is formed corresponding to at least one of ends of the feed opening in the longitudinal direction.

6. The printer according to claim 4,
wherein the cutout is formed corresponding to an area ranging from one end to an other end of the feed opening in the longitudinal direction.

7. The printer according to claim 1, further comprising
a housing including the feed portion,
wherein the feed tray is foldable along a top surface of the housing with the feed opening remaining exposed.
